(19) United States
(12) Patent Application Publication
(10) Pub. No.: US 2009/0041130 A1
(43) Pub. Date: Feb. 12, 2009

(54) METHOD OF TRANSMITTING PICTURE INFORMATION WHEN ENCODING VIDEO SIGNAL AND METHOD OF USING THE SAME WHEN DECODING VIDEO SIGNAL

(75) Inventors: Doe Hyun Yoon, Seoul (KR); Ji Ho Park, Seoul (KR); Seung Wook Park, Seoul (KR); Byeong Moon Jeon, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/914,947

(22) PCT Filed: May 25, 2006
(86) PCT No.: PCT/KR06/01981

§ 371 Date: Jul. 28, 2008

Related U.S. Application Data
(60) Provisional application No. 60/684,590, filed on May 26, 2005.
(60) Provisional application No. 60/701,041, filed on Jul. 21, 2005.
(60) Provisional application No. 60/706,443, filed on Aug. 9, 2005.

(30) Foreign Application Priority Data
Sep. 2, 2005 (KR) 10-2005-81904

(51) Int. Cl. H04N 7/26

(52) U.S. Cl. 375/240.26; 375/E07.026

(57) ABSTRACT

A method of transmitting picture information of a video signal from an encoder and a method of using the picture information in a decoder are provided. When a video signal is encoded, the video signal is coded according to a specified scheme while being divided into key and non-key pictures, and a value indicating whether or not coded picture data carried in each NAL unit is key picture data is recorded in a ‘nal_ref_idc’ field in a header of the NAL unit or, alternatively, a value (adaptive_ref_pic_marking_mode_flag=1) indicating that a Memory Management Control Operation (MMCO) is present and a control operation value indicating a key picture are recorded in a header of a picture coded into a key picture.

### 1. TECHNICAL FIELD

The present invention relates to a method of transmitting picture information of a video signal from an encoder and a method of using the picture information in a decoder.

### 2. BACKGROUND ART

Scalable Video Codec (SVC) encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of the sequence of pictures encoded according to a scalable scheme, there is still a problem in that the image quality is significantly reduced if the bitrate is lowered. One solution to this problem is to provide an auxiliary picture sequence for low bitrates, for example, a sequence of pictures that have a small screen size and/or a low frame rate, as illustrated in FIG. 1.

The auxiliary picture sequence is referred to as a base layer, and the main frame sequence is referred to as an enhanced or enhancement layer. Inter-layer prediction is performed to increase coding efficiency.

In the scalable video codec (SVC), a picture sequence of each layer may be divided into a quality base layer and an SNR enhancement layer to be encoded and transmitted as illustrated in FIG. 2 in order to ensure that a decoder realizes a higher image quality according to transmission channel conditions. The SNR enhancement layer includes encoded picture data of the difference between an original image picture and an encoded quality base layer picture. Additional decoding of the SNR enhancement layer provides video with a higher image quality than the basic image quality.

Quality base pictures alone may be used as reference pictures for inter-picture prediction. Alternatively, pictures produced from quality base pictures in which SNR enhancement layer picture data is reflected may be used as reference pictures for inter-picture prediction. The latter reduces the amount of coded data produced through prediction. However, if all or part of the SNR enhancement layer picture data is not transmitted due to an insufficient transmission channel capacity, an error occurs when decoding a picture, which must use the SNR enhancement layer picture data as reference picture data, and the error also propagates to the subsequent pictures.

In order to limit the error propagation, the SVC specifies pictures which must use only quality base pictures as their reference pictures. The specified pictures are referred to as ‘key pictures’. When pictures specified as non-key pictures (B pictures in the example of FIG. 2) are decoded, pictures reconstructed using not only quality base pictures but also SNR enhancement picture data are used as their reference pictures, as illustrated in FIG. 2. Accordingly, in the SVC, pictures are specified as key pictures or non-key pictures according to whether only quality base pictures or both quality base pictures and SNR enhancement picture data have been used for prediction of the pictures, so that the decoder is informed of whether the pictures are key or non-key pictures and can thereby perform appropriate decoding.

According to the scalable video codec, the same scheme (for example, MCTF) can be employed for both the enhanced and base layers. Different schemes (for example, MCTF for the enhanced layer and a scheme based on Advanced Video Codec (AVC) (also referred to as ‘H.264’) for the base layer) can also be employed for both the enhanced and base layers.

However, when the scheme based on AVC (hereinafter, referred to as an “AVC compatible scheme”) is employed for the base layer, the syntax of the existing AVC codec must not be violated. Since the AVC does not accommodate SNR enhancement pictures, the AVC provides no definition of a key picture and thus has no information structure for transferring information indicating whether or not a picture is a key picture.

Because of these facts, when the SVC employs a scheme compatible with different codec such as the AVC, there is a need to provide a method for transferring information indicating whether or not a picture is a key picture from the encoder to the decoder, which ensures that the AVC accommodates SNR enhancement picture data without violating the AVC syntax.

### 3. DISCLOSURE OF INVENTION

Therefore, the present invention has been made in view of the above circumstances, and it is an object of the present invention to provide a method for transferring information indicating whether or not a picture is a key picture through a header of each transmission unit carrying encoded video data.

It is another object of the present invention to provide a method for transferring information indicating whether or not a picture is a key picture through a memory management control operation which an encoder specifies to be performed when encoded video data is decoded.

In accordance with one aspect of the present invention, the above and other objects can be accomplished by the provision of a method for encoding and decoding a video signal, wherein, when a video signal is encoded, the video signal is coded according to a specified scheme while being divided into key and non-key pictures, and specific information, indicating whether or not coded picture data carried in each transmission unit is key picture data, is recorded in a header of the transmission unit, whereas, when an encoded video signal is decoded, specific information in a header of each transmission unit carrying encoded picture data is checked while receiving the transmission unit, and it is determined from a value of the specific information whether or not the picture data carried in the transmission unit is key picture data.

In accordance with another aspect of the present invention, there is provided a method for encoding and decoding a video signal, wherein, when a video signal is encoded, the video signal is coded according to a specified scheme while being divided into key and non-key pictures, and both a value indicating that a memory management control operation is present and a control operation (or command) value indicating a key picture is recorded in a header of a picture coded into a key picture, whereas, when an encoded video signal is decoded, it is determined from a header of each picture whether or not a memory management control operation is present while receiving encoded picture data, and it is determined whether or not a control operation value indicating a key picture is present if the memory management control operation is present and it is determined that the picture is a key picture if the control operation value indicating a key picture is present.

In an embodiment of the present invention, the specific information has a size of 2 bits.

In an embodiment of the present invention, the specific information has a value of 3 when the transmission unit carries key picture data, which is picture data of a lowest temporal level; a value of 0 when the transmission unit carries picture data of a highest temporal level; a value of 1 when the transmission unit carries picture data of a second highest temporal level; and a value of 2 when the transmission unit carries picture data of the remaining temporal levels.

In an embodiment of the present invention, the transmission unit is a Network Abstraction Layer (NAL) unit.

In another embodiment of the present invention, the control operation value indicating a key picture is assigned to a memory_management_control_operation defined in an Advanced Video Codec (AVC) and is preferably 7.

### 4. BRIEF DESCRIPTION OF DRAWINGS

The above and other objects, features and other advantages of the present invention will be more clearly understood from the following detailed description taken in conjunction with the accompanying drawings, in which:

FIG. 1 illustrates how picture sequences of a plurality of layers are encoded through inter-layer prediction;

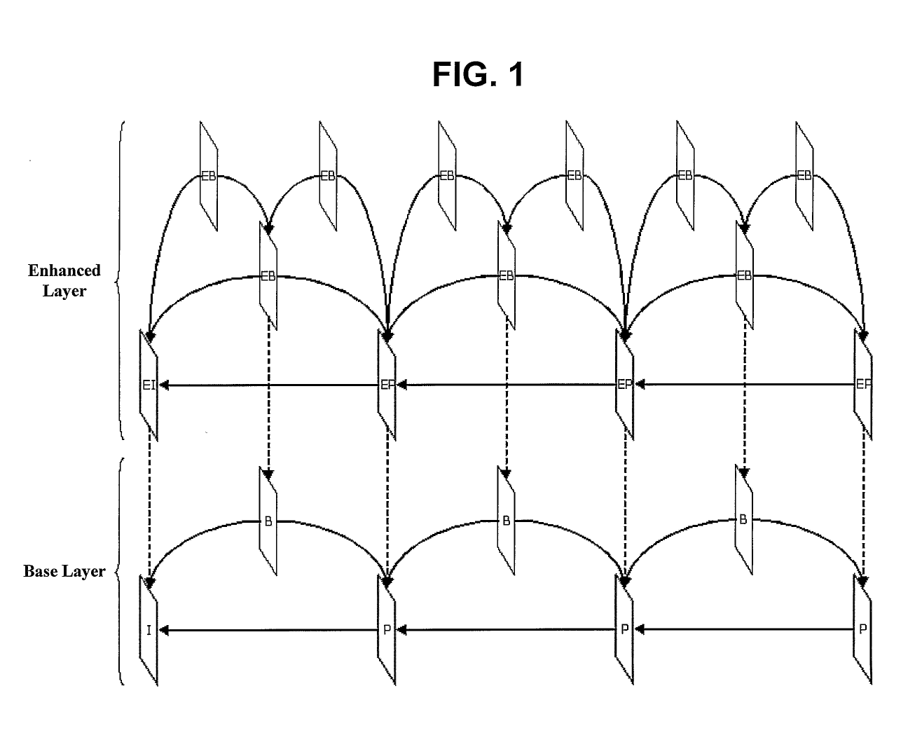

FIG. 2 illustrates how a picture sequence of a given layer, divided into a quality base layer and an SNR enhancement layer, is encoded;

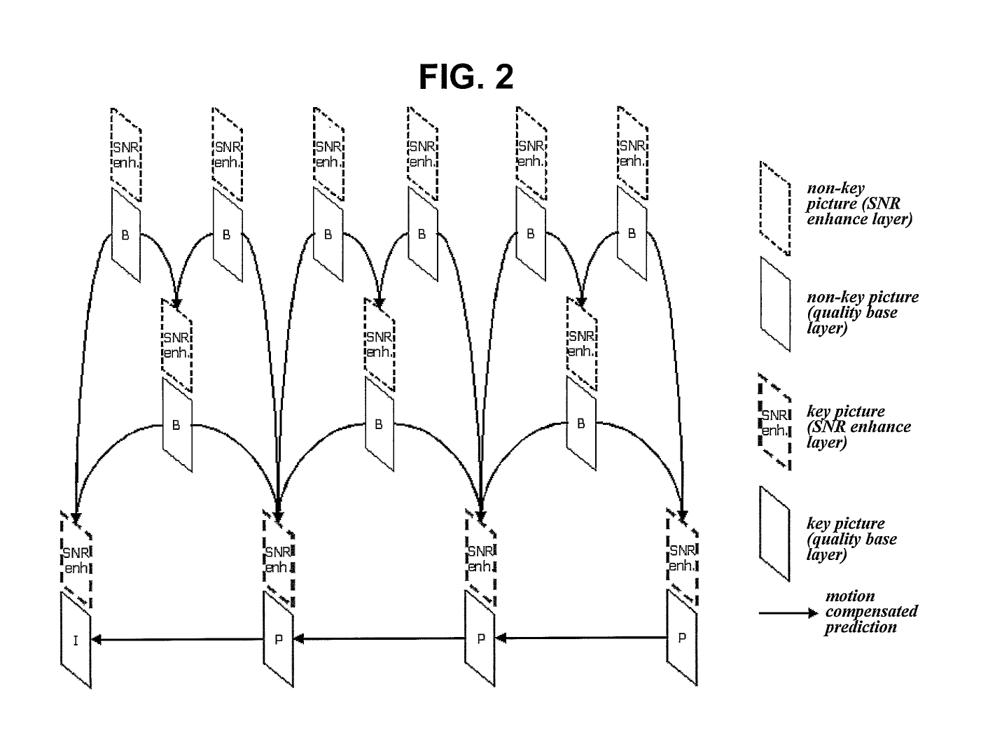

FIG. 3 illustrates the structure of an NAL unit, which is a transmission unit carrying encoded video data, and a header of the NAL unit according to an embodiment of the present invention;

FIG. 4 illustrates a method for assigning a value to a ‘nal_ref_idc’ field of a header of each NAL unit carrying data of a picture, based on a temporal level of the picture, according to an embodiment of the present invention;

FIG. 5 is a simple block diagram illustrating a decoding apparatus which performs an operation for determining whether a picture is a key or non-key picture according to the present invention;

FIG. 6 illustrates a decoding syntax associated with a procedure for determining whether or not a current slice belongs to a key picture, from a field for a Memory Management Control Operation (MMCO) in a slice header, according to another embodiment of the present invention.

### 5. MODES FOR CARRYING OUT THE INVENTION

Preferred embodiments of the present invention will now be described in detail with reference to the accompanying drawings.

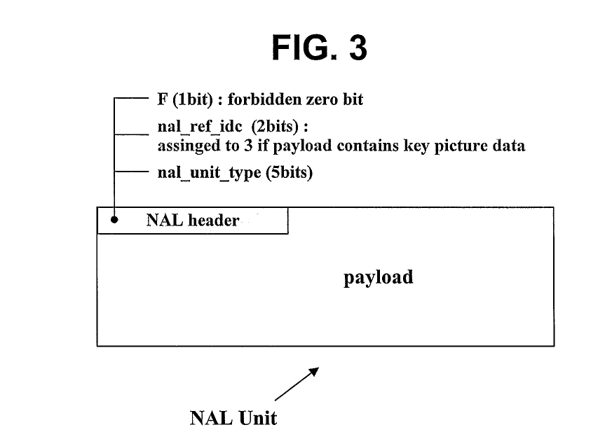

FIG. 3 illustrates a method for transmitting information indicating whether or not a picture is a key picture through a 2-bit ‘nal_ref_idc’ field in a 1-byte header of a Network Abstraction Layer (NAL) unit, which is a transmission unit carrying encoded video data, according to a preferred embodiment of the present invention.

When an encoder codes a picture into residual data through prediction using both a quality base picture and SNR enhancement picture data, the encoder specifies the picture as a non-key picture. On the other hand, when the encoder codes a picture into residual data through prediction using only a quality base picture, the encoder specifies the picture as a key picture.

The above definition of a key picture is just an example, and the present invention is not limited thereto. That is, pictures can also be divided into key and non-key pictures according to other criteria, and the present invention is characterized in that information indicating whether or not a picture is a key picture is transmitted through, for example, a ‘nal_ref_idc’ field.

For example, a ‘nal_ref_idc’ field in a header of each NAL unit carrying a picture specified as a key picture or partial data (hereinafter referred to as a “partition”) of the picture is assigned a value of “3”, and a ‘nal_ref_idc’ field in a header of each NAL unit carrying a picture specified as a non-key picture or a partition thereof is assigned one of a plurality of values “0” to “2” according to a temporal level to which the picture belongs. A ‘nal_ref_idc’ field in a header of each NAL unit carrying information such as a Sequence Parameter Set (SPS), Sequence Parameter Set Extension (SPSE), and a Picture Parameter Set (PPS) is also assigned a value of “3”.

When a slice is decoded in a decoding procedure, a flag “KeyPictureFlag” indicating whether or not the slice is included in a key picture is set or reset according to the value of a corresponding ‘nal_ref_idc” field as follows.

if (nal_ref_idc==3) KeyPictureFlag=1

else keyPictureFlag=0

The current AVC is defined such that a ‘nal_ref_idc’ field of each NAL unit carrying slice data of a specific type (for example, IDR NAL(nal_uit_type=5)) is assigned a value different from “0” where the term ‘slice’ refers to units into which a frame is divided, whereas a ‘nal_ref_idc’ field of each NAL unit carrying slice data of a different type (for example, slice data belonging to a picture not used as a reference picture) is assigned a value of “0”. Accordingly, the above method for assigning values to the ‘nal_ref_idc’ field according to the embodiment of the present invention does not violate the AVC syntax.

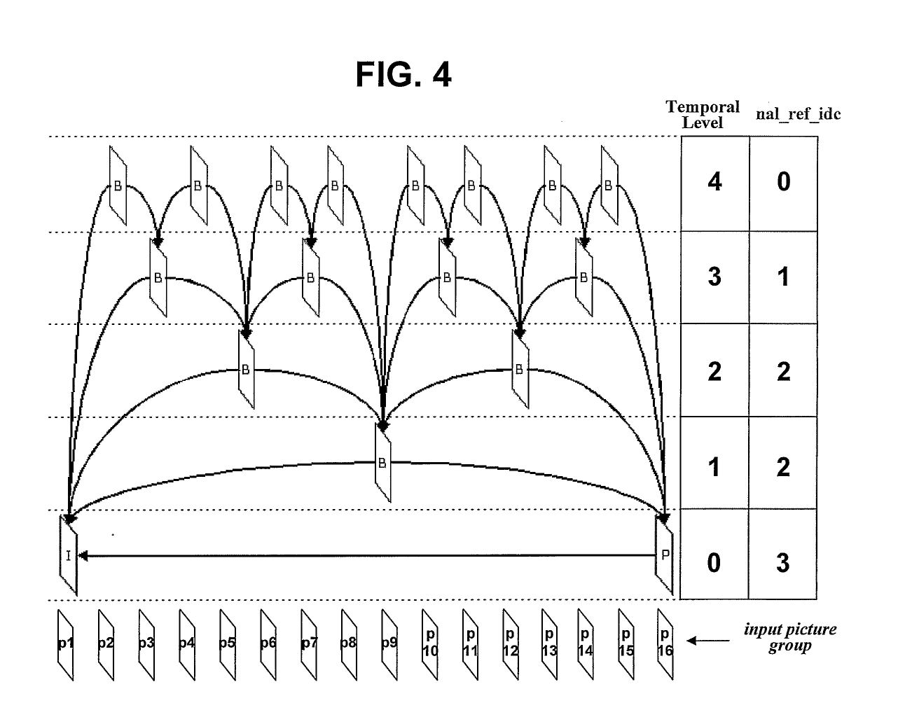

The above method for assigning a different value to the ‘nal_ref_idc’ field in each NAL unit carrying a picture depending on the temporal level to which the picture belongs will now be described in more detail with reference to an example of FIG. 4.

A first picture p1 of a picture group including a predetermined number of pictures (16 pictures in the example of FIG. 4) is intra-coded, and a last picture p16 thereof is coded into a P picture through prediction using the first picture p1 as a reference picture. Here, even if SNR enhancement picture data of the first picture p1 has been produced, a picture, in which the SNR enhancement picture data is reflected, is not used for prediction of the last picture p16 for coding into the P picture. In this manner, pictures of temporal level 0 are produced, which are key pictures. After coding, the pictures are encapsulated into NAL units. In this procedure, a ‘nal_ref_idc’ field of each NAL unit carrying data belonging to the pictures is assigned a value of “3”.

A picture p8 located in the middle of the picture group is then subjected to bidirectional predictive coding using the pictures of temporal level 0 as reference pictures, thereby producing a B picture. This bidirectional coding with reference to the pictures of temporal level 0 increases the temporal level by 1, and a ‘nal_ref_idc’ field of each NAL unit carrying data belonging to the B picture of temporal level 1 is assigned a value of “2”, which is one less than the value “3” assigned to the key pictures of temporal level 0.

Then, pictures p4 and p12 located midway between each of the 3 coded pictures p1, p8, and p16 are subjected to bidirectional coding with reference to their adjacent pictures (p1 and p8) and (p8 and p16) of the 3 coded pictures p1, p8, and p16, respectively. This bidirectional coding increases the temporal level by 1 so that two B pictures produced in this procedure are assigned temporal level 2.

The remaining pictures in the picture group are subjected to predictive coding and assigned temporal levels in the same manner as described above. The pictures are transmitted after a ‘nal_ref_idc’ field of each NAL unit carrying pictures of temporal level 2 is assigned a value of “2”, a ‘nal_ref_idc’ field of each NAL unit carrying pictures of temporal level 3 is assigned a value of “1”, and a ‘nal_ref_idc’ field of each NAL unit carrying pictures of temporal level 4 is assigned a value of “0”.

The following is a typical method for assigning a value to the ‘nal_ref_idc’ field. As illustrated in FIG. 4, when the last temporal level of the encoded pictures is level N (for example, level 4), a lowest value “0” is assigned to a ‘nal_ref_idc’ field of each NAL unit carrying pictures of level N, a value of “1” is assigned to a ‘nal_ref_idc’ field of each NAL unit carrying pictures of level (N−1), a value of “2” is assigned to a ‘nal_ref_idc’ field of each NAL unit carrying pictures in the range of levels 1 to (N−2), and a value of “3” is assigned to a ‘nal_ref_idc’ field of each NAL unit carrying pictures of level 0, which are key pictures. This assignment method is just an example, and values can be assigned to the ‘nal_ref_idc’ fields of the temporal levels in various other methods. However, any method maintains the principle that a value of “3” is assigned to the ‘nal_ref_idc’ field of the temporal level where key pictures are present, whereas a value different from “3” is assigned to the ‘nal_ref_idc’ field of the temporal level where non-key pictures are present.

The method for assigning the value of the ‘nal_ref_idc’ field as illustrated in FIG. 4 ensures that an AVC-compatible base layer decoder in an SVC decoder outputs a video sequence at a frame rate suitable for the current presentation environment of the base layer decoder without parsing slice data in payloads of NAL units.

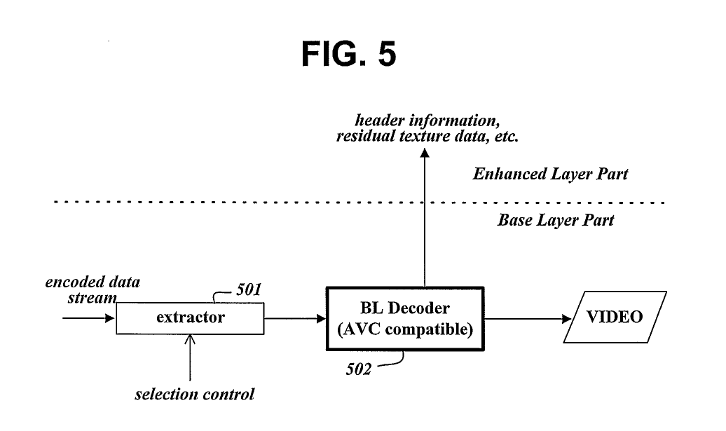

For example, in a decoding apparatus configured as shown in FIG. 5, an extractor 501 in the base layer part selects NAL units with ‘nal_ref_idc’ fields assigned a value of “31”, NAL units with ‘nal_ref_idc’ fields assigned a value of “2” or more, NAL units with ‘nal_ref_idc’ fields assigned a value of “1” or more, or all NAL units, according to a selection command (for example, input by the user) set based on the current output condition of a base layer (BL) decoder 502, which is an AVC-compatible decoder provided downstream of the extractor 501, and transfers the selected NAL units or all NAL units to the BL decoder 502.

On the other hand, an extractor (not shown) provided in an encoding apparatus can also perform the same selection operation as the above selection operation of the extractor 501 in the decoding apparatus. In this case, a server, which transmits encoded streams, sets a selection command or condition according to transmission channel conditions or based on information received from a remote user. The extractor in the encoding apparatus selects NAL units with ‘nal_ref_idc’ fields assigned a value of “3”, NAL units with ‘nal_ref_idc’ fields assigned a value of “2” or more, NAL units with ‘nal_ref_idc’ fields assigned a value of “1” or more, or all NAL units, according to the selection command set by the server, and transmits the selected NAL units to the decoding apparatus through a transmission channel. Although the following description is given with reference to the extractor 501 in the decoding apparatus, the same method can be applied to the extractor in the encoding apparatus.

If the extractor 501 extracts and transfers only NAL units with a ‘nal_ref_idc’ field assigned “1” or more to the BL decoder 502 when the received (or transmitted) base layer picture sequence is a video signal of 15 Hz, the NAL units are decoded into a video signal of 7.5 Hz. If the extractor 501 extracts and transfers only NAL units with a ‘nal_ref_idc’ field assigned “2” or more to the BL decoder 502, the NAL units are decoded into a video signal of 3.75 Hz. If the extractor 501 extracts and transfers only NAL units with a ‘nal_ref_idc’ field assigned “3” or more to the BL decoder 502, the NAL units are decoded into a video signal of 1.725 Hz, which is composed of only key pictures.

The above ‘nal_ref_idc’ assignment method allows the BL decoder 502 to determine from a header of each NAL unit whether or not picture data carried in the NAL unit is key picture data. Accordingly, the BL decoder can determine whether to use SNR enhancement picture data to obtain a reference picture for decoding the picture data. The BL decoder 502 can also obtain a video signal at a desired output frame rate simply by selecting NAL units based on information in headers of the NAL units, without parsing picture headers (or slice headers) present in payload data in the NAL units, so that the parsing load on the extractor is reduced.

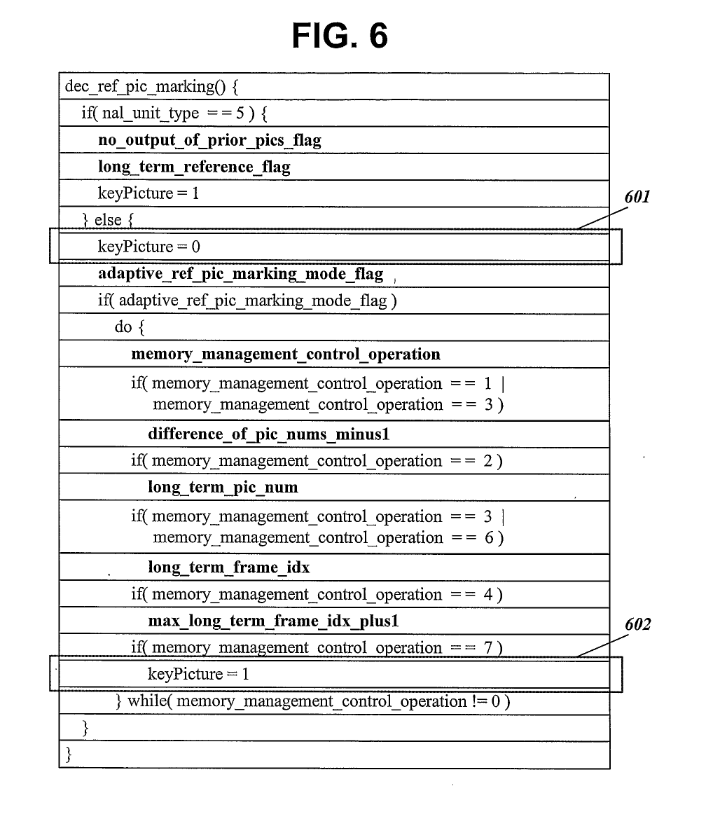

A method for transferring information indicating whether or not a picture is a key picture through a field for a memory management control operation (MMCO) present in a slice header according to another preferred embodiment of the present invention will now be described with reference to FIG. 6.

FIG. 6 illustrates a decoding syntax associated with a procedure by which the BL decoder 502 determines, from a field for MMCO in a slice header, whether or not a current slice belongs to a key picture according to the embodiment in which information indicating whether or not a picture is a key picture is transferred through a field for MMCO present in a slice header.

If data carried in a different unit from an IDR NAL unit (i.e., a NAL unit with nal_ref_idc=5) is data of a new slice, the BL decoder 502 initializes an internal variable “keyPicture” to “0”, which is a value indicating a non-key picture, (601) and checks the value of a flag “adaptive_ref_pic_marking_mode_flag” in a slice header of the new slice. If the checked “adaptive_ref_pic_marking_mode_flag” value is not zero, the BL decoder 502 checks a value corresponding to a command “memory_management_control_operation”. If the checked “memory_management_control_operation” value is in the range of 0 to 6, the BL decoder 502 performs an operation according to a conventional scheme specified for the value, and sets the initialized variable “keypicture” to “1” if the checked value of the command “memory_management_control_operation” is a value (for example, 7) out of the range of 0 to 6 (602).

The BL decoder 502 checks the internal variable “keypicture” upon completion of the analysis of the information of the slice header. If the checked value of the variable “keypicture” is 1, the BL decoder 502 determines that the currently received slice data is data of a key picture, and uses only a previously reconstructed quality base picture to obtain a reference picture required for decoding the picture, without using SNR enhancement picture data. If the checked value of the variable “keypicture” is 0, the BL decoder 502 determines that the currently received slice data is data of a non-key picture, and performs inverse prediction of the picture using a reference picture reconstructed additionally using SNR enhancement picture data. This inverse prediction reconstructs residual data of the picture to original image data.

On the other hand, if the checked “adaptive_ref_pic_marking mode_flag” value is “0” on indicating that the slice data has no MMCO requested, the initialized variable “keyPicture” remains 0, so that it is determined that the slice data is data of a non-key picture.

According to the decoding syntax illustrated in FIG. 6, if an encoded picture is a key picture, a video signal encoder adds a command “memory_management_control_operation” having a specific value (for example, “7”) to a header (for example, a slice header) of the encoded picture data, and sets a flag “adaptive_ref_pic_marking mode_flag” to “1”. Here, the flag “adaptive_ref_pic_marking_mode_flag” may already have been set to “1” for another MMCO request.

Whether a picture is a key or non-key picture could be determined using the value of the flag “adaptive_ref_pic_marking_mode_flag”. However, as this flag is information defined to indicate whether or not an MMCO is present, the use of this flag is not limited to key pictures. If an MMCO (for example, a control operation requesting that a ‘long_term_frame_idx’ value be set to indicate a currently decoded picture) is used for a non-key picture, the flag “adaptive_ref_pic_marking_mode_flag” can be “1” for both key and non-key pictures, so that it cannot be determined whether a picture is a key or non-key picture.

One might also consider using the MMCO only for key pictures so that whether or not a picture is a key picture can be determined simply from the flag “adaptive_ref_pic_marking_mode_flag”. However, this significantly limits the flexibility of the operation for managing buffers using an MMCO since the MMCO is not allowed for non-key pictures. Because of this fact, according to the embodiment of the present invention, preferably, a new value of “memory_management_control_operation” is defined and it is determined from the value whether or not a picture is a key picture.

Since conventional AVC decoders disregard the newly defined value and AVC-compatible decoders in SVC decoders can determine from the newly defined value whether or not received picture data is key picture data, it is possible to transfer information indicating whether or not a picture is a key picture without violating the existing AVC codec.

The decoder, which determines whether or not a picture is a key picture according to the method described above, can be incorporated into a mobile communication terminal, a media player, or the like.

As is apparent from the above description, a method for encoding and decoding a video signal according to the present invention ensures that information indicating whether or not a picture is a key picture can be transferred without violating the existing AVC when an AVC-compatible decoder is employed in an SVC decoder, thereby ensuring the benefits of AVC-based coding of video signals while improving the image quality using SNR enhancement picture data.

The method according to the present invention can also obtain a video sequence at a desired frame rate without imposing load on the decoder.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

1. A method for encoding a video signal, the method comprising the steps of:
a) coding the video signal according to a specified scheme while dividing the video signal into key and non-key pictures; and
b) recording, in a header of each transmission unit carrying coded picture data, information indicating whether or not the picture data carried in the transmission unit is key picture data.

2. The method according to claim 1, wherein the information has one of a first value assigned when the picture data carried in the transmission unit is key picture data and a plurality of values different from the first value, which are assigned according to a plurality of temporal levels at which the picture data is coded.

3. The method according to claim 2, wherein the information has a size of 2 bits, the first value is 3, and the plurality of values different from the first value are in a range of 0 to 2.

4. The method according to claim 3, wherein, at the step b), the information having a value of 0 is recorded in a header of each transmission unit carrying picture data of a highest temporal level (TL=N), the information having a value of 1 is recorded in a header of each transmission unit carrying picture data of a second highest temporal level (TL=N−1), the information having a value of 2 is recorded in a header of each transmission unit carrying picture data of a range of second lowest to third highest temporal levels (TL=1, . . . , N−3, N−2), and the information having a value of 3 is recorded in a header of each transmission unit carrying picture data of a lowest temporal level (TL=0).

5. A method for decoding a video signal, the method comprising the steps of:
a) checking specific information in a header of each transmission unit carrying encoded picture data while receiving the transmission unit; and
b) determining from a value of the specific information whether or not the picture data carried in the transmission unit is key picture data.

6. The method according to claim 5, wherein the specific information has one of a first value assigned when the picture data carried in the transmission unit is key picture data and a plurality of values different from the first value, which are assigned according to a plurality of temporal levels at which the picture data is coded.

7. The method according to claim 6, wherein the specific information has a size of 2 bits, the first value is 3, and the plurality of values different from the first value are in a range of 0 to 2.

8. The method according to claim 6, further comprising the step of:
selecting a transmission unit to be transferred according to a given output frame rate, based on the value of the specific information before checking the specific information at the step a).

9. The method according to claim 5, further comprising the step of:
c) using a picture reconstructed using a quality base picture or a picture reconstructed using both a quality base picture and SNR enhancement layer picture data as a reference picture for decoding the picture data carried in the transmission unit, according to the determination at the step b) as to whether or not the picture data is key picture data.

10. The method according to claim 5, wherein the transmission unit includes a Network Abstraction Layer (NAL) unit.

11. A method for encoding a video signal, the method comprising the steps of:
coding the video signal according to a specified scheme while dividing the video signal into key and non-key pictures; and
recording, in a header of a picture coded into a key picture, both a value indicating that a memory management control operation is present and a control operation value indicating a key picture.

12. The method according to claim 11, wherein the control operation value indicating a key picture is a value greater than 6.

13. A method for decoding a video signal, the method comprising the steps of:
a) determining from a header of each picture whether or not a memory management control operation is present while receiving encoded picture data; and
b) determining whether or not a control operation value indicating a key picture is present if the memory management control operation is present and determining that the picture is a key picture if the control operation value is present.

14. The method according to claim 13, wherein the control operation value indicating a key picture is a value greater than 6.

15. The method according to claim 13, wherein the step a) includes determining that the memory management control operation is present if an adaptive_ref_pic_marking_mode_flag defined in an Advanced Video Codec (AVC) has a value of 1.

16. The method according to claim 13, wherein the step b) includes determining that the picture is not a key picture if the memory management control operation is not present or if the control operation value indicating a key picture is not present although the memory management control operation is present.
